(19) United States
(12) Patent Application Publication
(10) Pub. No.: US 2009/0040595 A1
(43) Pub. Date: Feb. 12, 2009

(54) ARRAY OF SPATIAL LIGHT MODULATORS AN DMETHOD OF PRODUCTION OF A SPATIAL LIGHT MODULATOR DEVICE

(75) Inventors: Marc Andre De Samber, Eindhoven (NL); Michiel De Jong, Eindhoven (NL); Antonius Johannes Maria Nellissen, Eindhoven (NL); Nicolaas Johannes Anthonius Van Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,405

(22) PCT Filed: Nov. 3, 2005
(86) PCT No.: PCT/IB05/53588

§ 371 Date: May 2, 2007

(30) Foreign Application Priority Data
Nov. 9, 2004 (EP) 04105607.8

(51) Int. Cl. G02F 1/00; B23P 11/00

(52) U.S. Cl. 359/321; 29/428

(57) ABSTRACT

For the production of a SLM device, one mounts a spatial light modulator (SLM) (2) on a substrate (3) of the same material as the main material of the SLM (2) to be juxtaposed with the substrate (3). Particularly, silicon based SLMs (2) are mounted on a silicon substrate (3). This leads to arrays of SLMs (2) that maintain a high accuracy with respect to position of the SLMs (2) and planarity. To further improve the planarity, it is preferred to mount the SLMs (2) on the substrate (3) by soldering, using the self-aligning effect of solder connections (20).

The invention relates to an array of spatial light modulators and a method of production of a spatial light modulator device. More specifically, it relates to arrays of spatial light modulators as can be used in maskless lithography systems.

For the production of semiconductor devices, lithographic technologies are used. The most common approaches are based on the step-principle or on the step-and-scan-principle. Both approaches are working with masks providing the structure to be projected onto a substrate. The masks have to show a high degree of accuracy and are very expensive.

To avoid such high costs, especially for testing and producing only small numbers of semiconductor devices of one structure, so-called maskless lithography has been developed. Instead of masks, programmable spatial light modulators (SLMs) are used. This technology is explained in detail in U.S. Pat. No. 6,312,134 B1, which is herein incorporated by reference. Possible SLMs are for example deformable micro-mirror devices for working in the reflection mode or liquid crystal light valves for working in the transmission mode.

A SLM comprises a multitude of units like deformable mirror-devices or liquid crystal light valves, each corresponding to a pixel of the structure to be illuminated. Every pixel can be switched between the two states, i.e. illuminating or not illuminating the corresponding point on the wafer surface. Some SLMs have units with also an intermediate state, illuminating the corresponding point on the substrate surface with an intermediate intensity.

The digitalized structure to be projected is provided by a control unit, that controls every pixel and can switch the corresponding unit into the necessary state. If the structure to be projected is changed, the states of the units of the SLM are changed, too, where necessary.

For larger structures or multiple simultaneous projection of a structure on a substrate, a plurality of SLMs have to be arranged in a planar configuration with very tight specifications in terms of x- and y-position and planarity.

The known approach for meeting these specifications is based on using sophisticated combinations of transducers and multiple stages.

It is an object of the present invention to provide an easy to handle array of SLMs that is easy to produce.

In a first aspect of the present invention, there is provided a method for the production of a SLM device, comprising the step of mounting a spatial light modulator on a substrate of the same material as the main material of the SLM array to be juxtaposed with the substrate. Particularly, silicon based SLMs are mounted on a silicon substrate.

A SLM device may comprise a single or a plurality of SLMs, leading to an array of SLMs. The present invention is independent of the number of SLMs used and works as well for a single SLM array as for a plurality of SLMs.

The special choice of the substrate material leads to a perfect thermal match of substrate and SLM. This is a very important step in achieving the severe specifications with respect to position and planarity for use in a maskless lithography system. During illumination of the SLM device, impinging photons deposit energy in the SLM device inducing a substantial thermal load. Different coefficients of thermal expansion of the substrate and the SLMs would lead to major deformations of the SLM device, thus making it eventually impossible to reach the specifications. By selecting the substrate material to match the material of the SLMs, specifically the main material to be juxtaposed with the substrate, e.g. a carrier substrate of the SLM itself, both substrate and SLM behave in the same way, when heated, such that only a scale effect with respect to x- and y-positions has to be taken into account during illumination, but no deformations.

In preferred embodiments of the present invention, the SLM is mounted by using surface mount technology, preferably by soldering. This has the advantage, especially if using a solder with high surface tension, that the self-aligning effect of solder during reflow due to minimizing the surface energy of the solder provides SLM devices of low variation with respect to position and planarity. This helps meeting the severe specifications and lowers production cost.

In preferred embodiments of the present invention, the substrate is preformed to provide it with an opening for exposing the SLM. Preferably, only one side of the substrate is provided with the infrastructure for the SLM such as electronic circuits, connectors etc. The other side can be processed to be optimized for optical use like having a defined reflection or absorption characteristic.

Both measures arc especially useful, when arranging the SLM in a flip-chip geometry. Then, the optically active side of the SLM is oriented such that it is exposed to the light, when being illuminated, as well as the side of the substrate optimized for optical use, while all the infrastructure is on the other side of the substrate. This has the advantage, that the infrastructure is not endangered by the light, particularly when using deep ultra-violet light, and that the infrastructure does not impede a correct illumination e.g. by generating stray light.

In a further aspect of the present invention, an array of SLMs on a substrate is provided, wherein the substrate is of the same material as the main material of the SLMs to be juxtaposed with the substrate. The SLMs may be mounted on the substrate by means of solder-defined self-aligning connections and/or be arranged in flip-chip geometry, the substrate laving openings for exposing the SLMs, the infrastructure for the SLMs being provided on one side of the substrate, while the other side has a defined reflection or absorption function.

In a last aspect to the present invention, a maskless lithography system with such an array of SLMs is provided.

A detailed description of the invention is provided below. Said description is provided by way of a non-limiting example to be read with reference to the attached drawings in which:

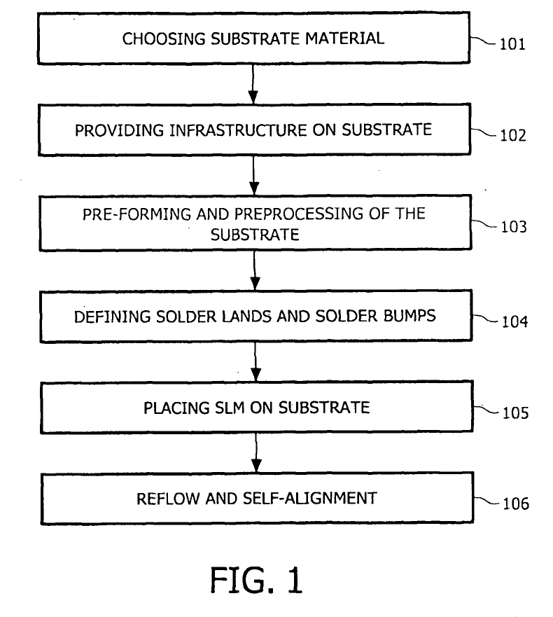

FIG. 1 shows an embodiment of the production method according to the invention;

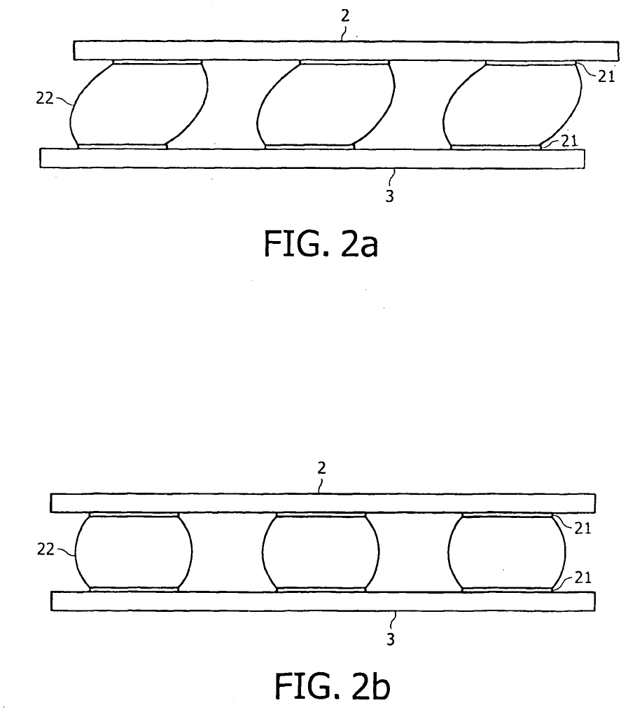

FIGS. 2a,b show a solder connection before and after reflow;

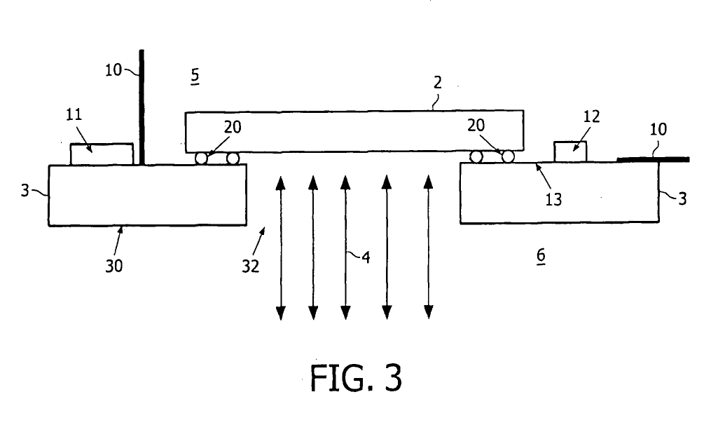

FIG. 3 shows a SLM mounted on a substrate;

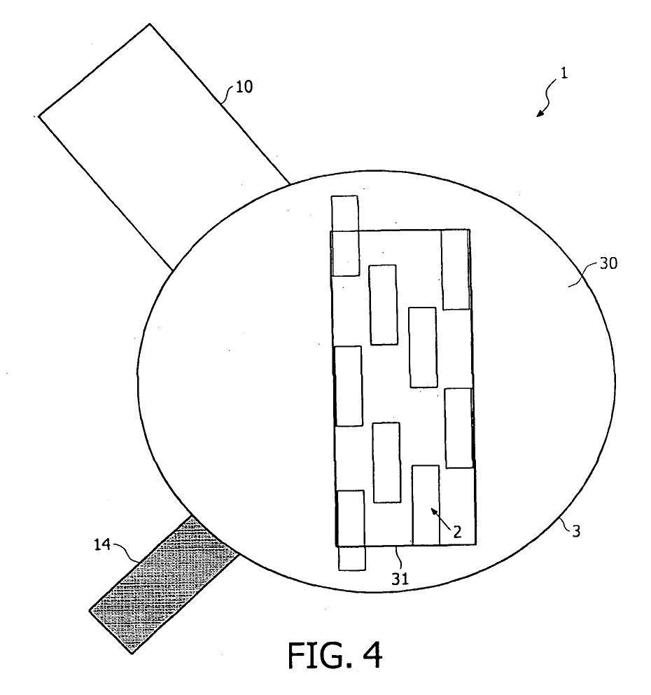

FIG. 4 shows the light side of an array of SLMs;

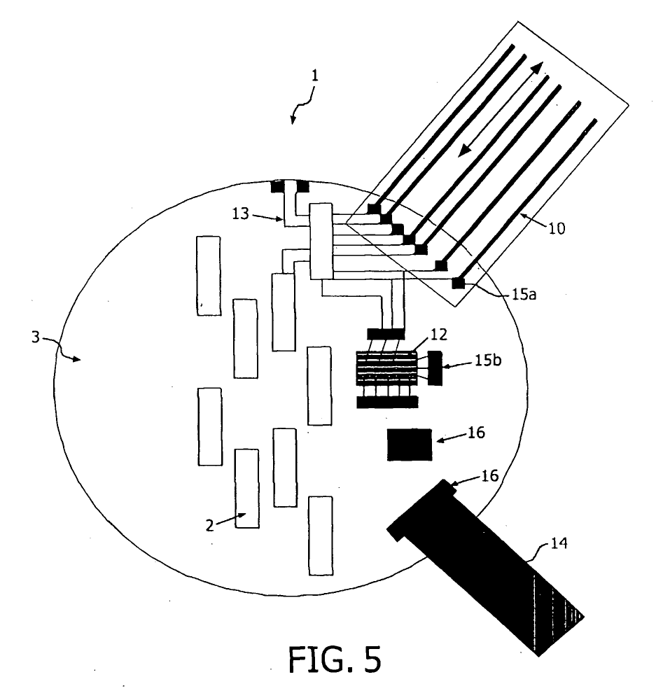

FIG. 5 shows the dark side of an array of SLMs;

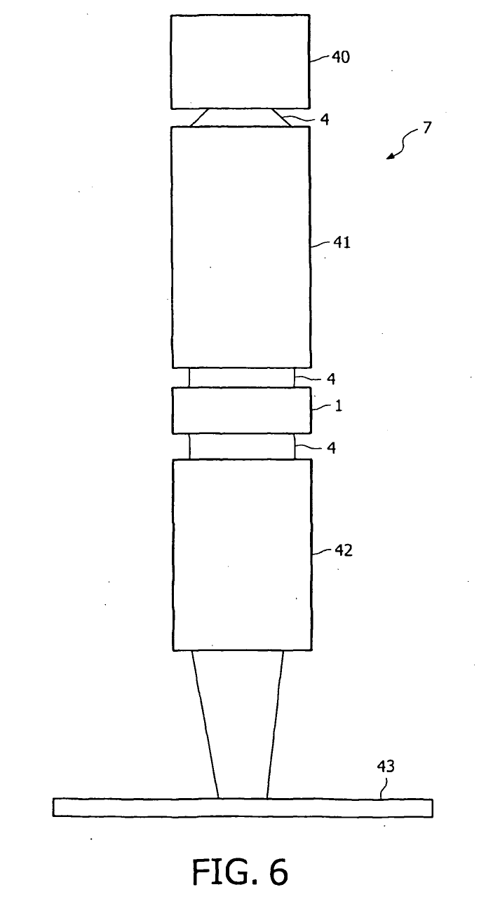

FIG. 6 Shows a basic sketch of a maskless lithography system;

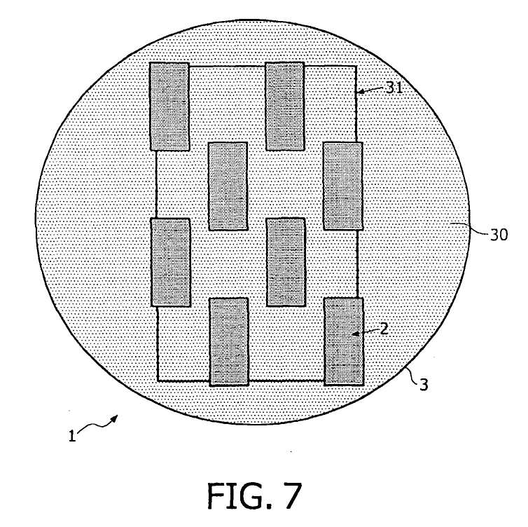

FIG. 7 shows the light side of a regular array of SLMs.

FIG. 1 shows an embodiment of the production method according to the invention. In a first step 101, one has to choose the appropriate material for the substrate depending on the SLM to be mounted on the substrate. Most SLMs are semiconductor devices, i.e. the SLM is arranged on a carrier substrate. This carrier substrate is the part of the SLM that will actually be juxtaposed with the substrate. Therefore, the substrate material is to be chosen to be the same as the material of the carrier substrate to get a perfect thermal match.

It will be noted, that the described method works not only for a single SLM, but also for two, three, or a plurality of SLMs.

Once the substrate material is chosen, in a next step 102, the side of the substrate opposite to the light side (so-called dark side) is provided with all the necessary infrastructure for the SLM, e.g. flex connections, preamplifiers, electrical circuitry, thin film interconnects, connection pads, microconnectors etc. Some components have to be quite near to the SLM like preamplifiers, whereas other components can be farther away and connected with the SLM by thin film interconnects and/or flex connectors.

Following the pre-forming and preprocessing of the substrate, the substrate is pre-formed (step 103) to provide it with an opening corresponding to the size of the optically active surface of the SLM to be used, and preprocessed to provide one side of the substrate (so-called light side) with a finishing layer for providing defined absorption or reflection characteristics. Preferably, the finishing layer is an anti-reflection layer, such as for example a chromium oxide layer as is used on photomasks. Another advantageous possibility is to use a UV light absorbing layer, especially an absorbing polymer layer as is used in integrated circuit fabrication processes.

Then, the actual mounting of the SLM on the substrate can take place. In step 104, the solder lands are accurately defined and the solder bumps carefully controlled, before placing substrate and SLM accurately together in step 105. The solder lands or solderable interconnect pads are defined on both the substrate and the carrier substrate of the SLM, whereas the solder bumps are placed only on the solder lands of either the substrate or the SLM. Solder lands are accurately defined by etching windows in e.g. a silicon nitride passivation layer on the substrate, using photolithography and reactive ion etching. Preferably, a solder with high surface tension is used. Very much preferred are solders, which have a high tin content.

The last step 106 is the reflow leading to self-alignment of the SLM with respect to the substrate. One possible reflow process could be the following: First, the SLM device is preheated to gradually heat it up. The device is then kept at a temperature near to the temperature at which solder bonding can occur till all parts of the SLM device have reached the same temperature. The actual reflow is, when the device is heated to a temperature above the melting point of the solder for bonding. Afterwards, the SLM device is cooled evenly to avoid thermal shock. The reflow process may occur in an inert or eventually reducing atmosphere, in order to prevent oxidation of the solder bumps, which in turn would hamper the self-aligning process.

The self-alignment during reflow is illustrated in more detail in FIGS. 2a and 2b. FIGS. 2a and 2b show a SLM 2 and a substrate 3. Both SLM 2 and substrate 3 are provided with solder lands 21 and are in contact via solder bumps 22. In FIG. 2a is shown the state before reflow, in which SLM 2 and substrate 3 are poorly aligned. In the reflow process, when the solder bumps 22 become liquid, due to minimization of free energy, the free surface of the solder bumps 22 is minimized. This leads to accurate alignment of the substrate 3 and the SLM 2. The alignment is not only reached for the displacement in the XY-plane, but also for the rotation in the XY-plane and the out-of-plane rotation.

Calculated examples show that submicron accuracy, especially a x- and y-position accuracy equal or better than 0,5 μm, can be achieved, when using a fair number of bumps. It has been derived that the expectation value of accuracy scales with the number of bumps used. For example, a 40 mm square chip with 1600 IOs has two rows of solder lands and bumps at pitch of 200 μm. The solder land diameter is 100 μm. The nominal stand-off is 80 μm with an individual spread in the order of several micrometers. In order to have a resulting angle less than 7 μrad, the variation in bump height should be less than 2 μm. It allows for a 3% variation in deposited solder volume per bump.

FIG. 3 shows a SLM 2 on silicon basis mounted onto a silicon substrate 3. The SLM 2 is arranged in flip-chip geometry on the substrate 3, such that the optically active side of the SLM 2 is exposed to the illuminating light beam 4 through the opening 32. The side 6 of the substrate 3 that is exposed-to the light 4 is the light side 6. A finishing layer 30 has been deposited on the light side 6 of the substrate 3 to provide defined absorption or reflection characteristics. On the opposite side 5 of the substrate 3, the dark side 5, the SLM 2 is fixed to the substrate 3 by solder connections 20. The SLM shown in FIG. 3 is used in reflection mode and is based on micro-mirror devices.

The infrastructure for the SLM 2 is provided on the dark side 5, e.g. a preamplifier 11, flex connections 10, that can be oriented in any direction, fine pitch thin film interconnects 13 and electrical circuitry 12. Dividing the SLM device into a light side 6 and a dark side 5 has two major advantages: The infrastructure is protected from the illuminating light 4, and the infrastructure does not impede the imaging process, as it is hidden.

FIG. 4 shows the light side of an array 1 of SLMs 2. The SLMs 2 are arranged in an optically active area 31 of the substrate 3, that is actually to be illuminated. The substrate 3 has an antireflection or absorbing finishing layer 30 to make sure, that any structure to be projected on e.g. a wafer is due only to the SLMs 2 and not to any stray reflects of the substrate. The normal flex connection 10 and the micro-fine pitch connection 14 are the only parts of the infrastructure from the dark side of the substrate 3 that are visible, but very far away from the optically active area 31.

One will notice, that the SLMs 2 of the optically active area 31 are arranged in an irregular manner in FIG. 4. The invention is applicable to any arrangement of SLMs, e.g. to a regular arrays 1 as illustrated in FIG. 7.

FIG. 5 shows the dark side of an array 1 of SLMs 2. Besides the SLMs 2, diverse components operating as infrastructure for the SLMs 2 are mounted on the substrate 3. As example are shown a flex connection 10 connecting the SLMs 2 via fine pitch thin film interconnects 13 and pads 15a with a control unit, e.g. a computer, where the structure data to be implemented by the SLMs 2 is provided, circuitry 12 connected via connecting pads 15b, and micro-connectors 16, e.g. for connecting micro-fine pitch connections 14.

FIG. 6 sketches a basic maskless lithography system 7. Light 4 is emitted by a light source 40. The illuminating system optimizes the light 4 for illumination of the array 1 of SLMs. In the present example, the array 1 is used in transmission with SLMs based on liquid crystal light valve devices. The light 4 transmitted by the array 1 of SLMs is projected on the wafer 43 for imaging with the help of a projection system 42.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 array of SLMs
2 SLM
3 substrate
4 light
5 dark side
6 light side
7 maskless lithography system
10 flex connection
11 preamplifier
12 electrical circuitry
13 thin film interconnect
14 micro-fine pitch connection
15a,b pad
16 microconnector
20 solder connection
21 solder land
22 solder bump
30 finishing layer
31 optically active area
32 opening
40 light source
41 illumination system
42 projection system
43 wafer

1-15. (canceled)

16. A method for the production of a spatial light modulator device by mounting a spatial light modulator on a substrate of the same material as the main material of the spatial light modulator to be juxtaposed with the substrate, comprising the step of pre-forming the substrate to provide the substrate with an opening for exposing the spatial light modulator.

17. The method according to claim 16, wherein a silicon-based spatial light modulator is being mounted on a silicon substrate.

18. The method according to claim 16, comprising the further step of mounting the spatial light modulator on the substrate by using surface mount technology.

19. The method according to claim 16, comprising the further step of mounting the spatial light modulator on the substrate by soldering.

20. The method according to claim 16, comprising the further step of mounting the spatial light modulator on the substrate by defining solder lands and solder bumps, putting the spatial light modulator and the substrate together, and making use of the effect of minimization of free surface of the solder bumps during reflow for self-alignment of the spatial light modulator with respect to the substrate.

21. The method according to claim 18, wherein a solder with high surface tension is used.

22. The method according to any of claims 18, wherein a solder with a high tin content is used.

23. The method according to claim 16, wherein the spatial light modulator is arranged in a flip-chip geometry on the substrate.

24. The method according to claim 16, comprising the further step of
providing the infrastructure for the spatial light modulator on only one side of the substrate.

25. The method according to claim 16, comprising the further step of processing the other side of the substrate to attain a defined reflection or absorption.

26. An array (1) of spatial light modulators (2) on a substrate (3), wherein the substrate (3) is of the same material as the main material of the spatial light modulators (2) to be juxtaposed with the substrate (3) and wherein the substrate (3) has openings (32) for exposing the spatial light modulators.

27. The array according to claim 26, wherein
the spatial light modulators (2) are arranged in flip-chip geometry;
the infrastructure (10, 11, 12, 13, 14, 15a,b, 16) for spatial light modulator (2) is provided on one side (5) of the substrate (3), while the other side (6) has a defined reflection or absorption function.

28. The array according to claim 26, wherein the spatial light modulators (2) are mounted on the substrate (3) by means of solder-defined self-aligning connections (20).

29. A maskless lithography system (7) with an array (1) of spatial light modulators (2) according to claim 26.
